(19) United States
(12) Patent Application Publication
(10) Pub. No.: US 2016/0341356 A1
(43) Pub. Date: Nov. 24, 2016

(54) GRAVITY POWERED WEAPON HANGER DEVICE AND METHOD

(71) Applicant: Gregory Samaras, Whitestone, NY (US)

(72) Inventor: Gregory Samaras, Whitestone, NY (US)

(21) Appl. No.: 15/158,229

(22) Filed: May 18, 2016

Related U.S. Application Data
(60) Provisional application No. 62/163,134, filed on May 18, 2015.

(51) Int. Cl. F16M 13/02; F41B 5/14

(52) U.S. Cl. CPC F16M 13/02; F41B 5/14; F16M 2200/041; F16M 2200/021; F16M 2200/06

(57) ABSTRACT

A weapon hanger device is disclosed. The device uses the weight of a counterweight element attached to a hanger arm to power automatic pivoting of the device out of a user's way when the device is not needed. A related method is also disclosed.

### CROSS-REFERENCE TO RELATED APPLICATIONS

This application claims the benefit and priority to U.S. Provisional Application No. 62/163,134 filed May 18, 2015, and entitled “A Gravity Powered Weapon Hanger Device and Method.”

### FIELD OF THE TECHNOLOGY

The subject matter disclosed herein generally relates to hunting accessories and devices for hanging a bow or other weapon while in a tree stand, blind, or other hunting position. More particularly, the invention provides a device which automatically retracts out of the user's way when not in use. A related method is also provided.

### BACKGROUND

Hunters often experience long periods of time during which they are waiting for game to appear or are waiting for an opportunity to take a shot. These long periods are often spent in a tree stand, blind, or other uncomfortable position. While a hunter may prefer to be able to relax during this time, it is necessary that the hunter be ready to immediately react to the presence of game and fire whatever weapon is being used. This preparation is especially important when a hunter is using a bow due to the time and movement required to draw the bowstring and arrow back. In order to be prepared to fire quickly, a hunter may often choose to have the bow or other weapon already drawn and in position to fire. Having the bow or weapon held in position also helps reduce the risk of scaring the game before firing and/or losing the chance to fire.

While having the bow and arrow ready to fire may be preferable to the hunter, holding the bow in position for long periods while waiting for prey to appear is often not feasible. Thus, various weapon hangers or rests may be used. Hangers and rests may also be used with other weapons. While these weapons may not require as long to prepare to fire and may not be as difficult to hold in a firing position for long periods of time, a user may still enjoy the option of being able relax while the weapon is in position in a hanger or rest.

While hunters currently use various bow hangers to support their bows and other weapons, these suffer from certain defects such as getting in the hunter's way when aiming. Others may scare or frighten game away as they are moved out of the hunter's shot either because of their movement or noises produced by their movement. Some bow hangers permit a user to move the hanger out of the way; however, such action may take the user's attention away from the game and lining up a good shot. It may also result in additional movement and noise likely to spook or scare the game and alert them to the hunter's presence.

Thus, an effective and reliable weapon hanger device which automatically retracts out of the hunter's way would be well received in the art.

### SUMMARY

According to one aspect, a weapon hanger device which automatically retracts out of a user's way comprises a base; a hanger arm supported by the base, the hanger arm having a weapon attachment point; and a counterweight connected to the hanger arm.

According to a second aspect, a method of automatically retracting a weapon hanger device comprises: providing a weapon hanger device, including: a base; and a hanger arm connected to or supported by the base, the hanger arm having a weapon attachment point attached to the hanger arm, wherein a weapon is supported by the weapon attachment point; attaching a counterweight to the hanger arm at an end opposite the weapon attachment point, the counterweight and hanger arm being capable of pivoting around a portion of the base; removing the weapon supported by the weapon attachment point; automatically pivoting the counterweight downward as a result of gravity when the weapon supported by the weapon attachment point is removed; and automatically pivoting the hanger arm upward as a result of the step of automatically pivoting of the counterweight downward.

According to a third aspect, a weapon hanger device, comprises: a base, the base having a balance hook disposed under the rest of the base; a hanger arm connected to a counterweight, wherein the hanger arm includes a weapon attachment hook; wherein a portion of the hanger arm or the counterweight is placed in the balance hook such that the two are capable of pivoting.

### BRIEF DESCRIPTION OF THE DRAWINGS

The subject matter which is regarded as the invention is particularly pointed out and distinctly claimed in the claims included at the conclusion of this specification. The foregoing and other features and advantages of the invention are apparent from the following detailed description taken in conjunction with the accompanying drawings in which:

FIG. 1 depicts a perspective view of a weapon hanger device in accordance with one embodiment;

FIG. 2 depicts a perspective view of a weapon hanger device in accordance with one embodiment;

FIG. 3 depicts a perspective view of a weapon hanger device in accordance with one embodiment.

### DETAILED DESCRIPTION

A detailed description of the hereinafter described embodiments of the disclosed apparatus and method are presented herein by way of exemplification and not limitation with reference to the Figures.

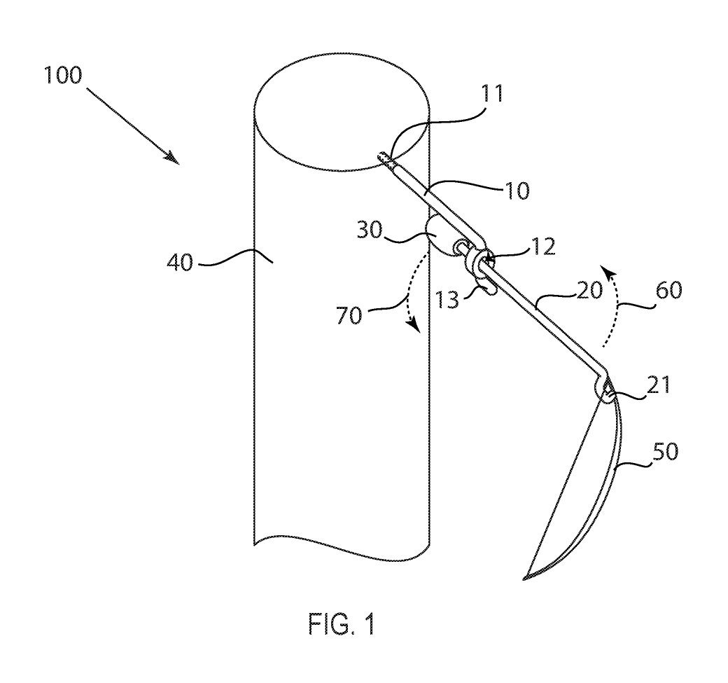

Referring now to FIG. 1, there is shown one embodiment of a weapon hanger device 100, comprised of a base 10, a hanger arm 20, and a counterweight 30. The base 10 may be made of any sufficiently rigid or sturdy material such as metals, woods, plastics, composites, or combinations of these. In one embodiment the base 10 is designed to be positioned in a substantially horizontal or parallel orientation with reference to a ground surface.

An end of the base 10 may include an attachment means 11. This attachment means 11 may be a screw, a spike, a stake, a strap, a cord, a wire, or any other suitable means for attaching the weapon hanger device 100 to a support 40. The support 40 may be a tree, a post, or any other stable object to which the weapon hanger 100 may be attached. In one embodiment, the support 40 is a tree and the attachment means 11 comprises a screw which may be twisted into the tree. The attachment means 11 may be configured to attach to a support 40 in any direction or angle from the base 10. For example, the attachment means 11 may extend from the base 10 in substantially the same direction as the base 10, or may extend at a ninety degree angel in order to attach the base 10 above or below a support 40 which is of a horizontal nature. Further, the attachment means 11 may extend from the base 10 at any angle in order to be customizable for use with any support 40.

At an end opposite the attachment means 11, the base 10 may support or be otherwise connected to a hanger arm 20. In one embodiment, the base 10 may include an opening 12 through which the hanger arm 20 may pass. The base 10 may also include a support tab 13 which extends past the opening 12 to provide support for the hanger arm 20. In one embodiment, the support tab 13 may be located under at least a portion of the hanger arm 20.

As shown in FIG. 1, in at least one embodiment, when the device 100 is supporting a weapon 50, the hanger arm 20 may extend in a substantially similar plane from the support 40 as the base 10 and in a substantially similar horizontal or parallel orientation to the ground surface. Alternatively, in some embodiments the device 100 may be arranged such that the hanger arm 20 may extend in a different plane or at a different angle if preferred.

The hanger arm 20 may be made of any suitable material. For example, woods, metals, plastics, composites, or combinations of any of these may be used, provided the material is strong enough to support the weight of a bow or other weapon 50.

The hanger arm 20 may include one or more weapon attachment points 21. The weapon attachment points 21 may be located at the end of the hanger arm 20 farthest from the point of connection to the base 10 and the support 40 or at other points along the hanger arm 20. The weapon attachment point 21 may be a hook, noose, slot, groove, or any other feature capable of receiving or supporting a bow or other weapon 50. Various weapon attachment points 21 will be readily known to those having skill in the art.

The weapon attachment point 21 may extend from the hanger arm 20 in substantially the same direction or plane as the hanger arm 20. Alternatively, the weapon attachment point 21 may be configured to project from the hanger arm 20 at some other angle in order to more conveniently place the weapon 50 for the user. The weapon attachment point 21 may also be rotatable or otherwise adjustable to facilitate ease of use by either a right-handed or left-handed user or ease of use in a variety of environments and positions.

At the end closest to the base 10 and support 40, or at some other point, the hanger arm 20 may be connected to a counterweight 30. Connection may be accomplished by a variety of means which will be well-known in the art. For example, the two elements may be formed of one piece of material, or permanently or semi-permanently attached. The hanger arm 20 and the counterweight 30 may connect by a threaded means, by a snap fit, by a tension fit, etc. If desired, a connection portion may be utilized between the hanger arm 20 and the counterweight 30. The counterweight 30 may be of any sufficiently heavy material and of any suitable shape or size. In one embodiment, the counterweight 30 is positioned below the base 10. A portion of the hanger arm 20, the counterweight 30, a combination of the two, or the connection portion between the two may pass through the opening 12 in base 10 in order to facilitate connection of the counterweight 30 to the hanger arm 20.

The size of the opening 12 may be varied as desired. For example, it may be wide enough to allow insertion and/or removal of both the hanger arm 20 and the counterweight 30. Alternatively, it may be of a specific size to prevent movement of the counterweight 30 in the direction of the hanger arm 20, or to prevent movement of the hanger arm 20 in the direction of the counterweight 30. Still further, the opening 12 may only be wide enough to receive a connection portion between the hanger arm 20 and the counterweight 30.

In one embodiment, when the weapon hanger device 100 is in use, a bow or other weapon 50 may be attached to the weapon attachment point 21 at the end of hanger arm 20.

If the total weight of the bow 50, the hanger arm 20, and the weapon attachment point 21 is sufficient compared to the weight of the counterweight 30, the hanger arm 20 may be pulled in a downward direction, and may pivot in the opening 12 of the base 10. When this happens, the connected counterweight 30 may also be pulled in an upward direction, and may also pivot in the opening 12 of the base 10. The hanger arm 20 may be prevented from pivoting farther than a selected angle by support tab 13. Similarly, the counterweight 30 may be prevented from pivoting farther than a selected angle or position by contact with the underside of base 10. Since the hanger arm 20 and the counterweight 30 are in connection with one another, impediment of the movement of either will serve to position the device 100 properly to support the bow or other weapon 50.

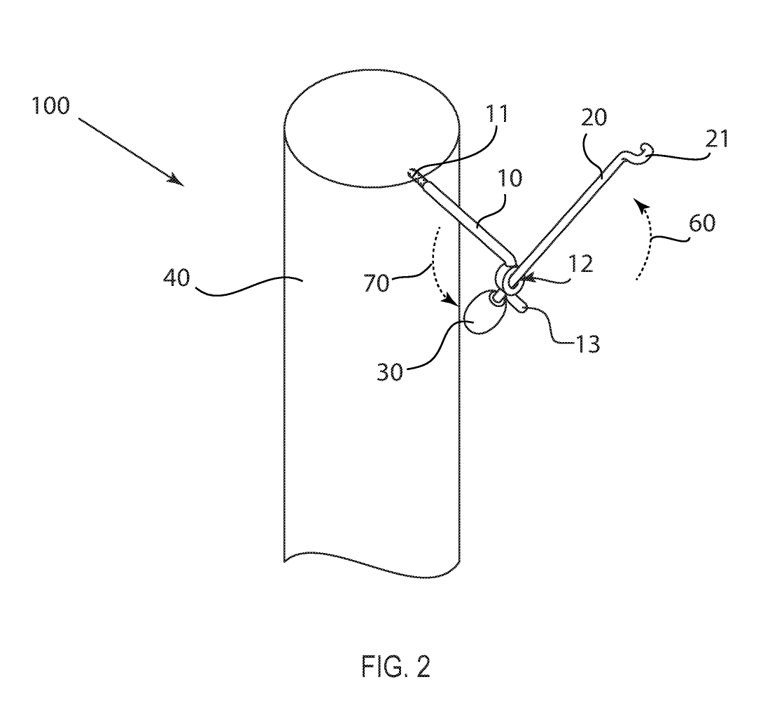

Conversely, a force of gravity on the counterweight 30 may be greater than a gravitational force operating on hanger arm 20 and the weapon attachment point 21 when a bow or other weapon 50 is not attached. Thus, as depicted in FIG. 2, when gravity acts upon the counterweight 30, it may swing in a downward direction as shown by element 70. Due to the connection between the hanger arm 20 and the counterweight 30, this force may simultaneously pull the hanger arm 20 in an upward direction as shown by element 60. The hanger arm 20 and the counterweight 30 may thus pivot in their respective directions in the opening 12 of the base 10. During this process, the hanger arm 20 may retract upwardly and out of the user's way, removing the hanger arm 20 from the user's immediate vicinity. Thus, the weapon hanger device 100 may automatically retract, removing any obstruction to the user's aiming or firing of the bow or other weapon 50.

The rotation of the counterweight 30 and hanger arm 20 may be calculated to provide a specific angular velocity or rate of movement of the hanger arm 20 and counterweight 30. This may be done by calculating a net torque placed upon the hanger arm 20, the counterweight 30, and any connection portion between them, as a system. In some embodiments, the torque of the counterweight 30 may be only slightly greater than the torque caused by the hanger arm 20 (and any included weapon attachment point 21). Thus, in these embodiments the hanger arm 20 may slowly pivot out of the user's way. It will be understood by those having skill in the art that the torque may be changed by altering the respective weights of the hanger arm 20, the counterweight 30, or the connection portion. It will also be appreciated that altering the distance from a point at which the system pivots—in this case the system will pivot at the opening 12 of the base 10—will change the torque placed upon the system. For example, a lighter counterweight 30 disposed farther away from the opening 12 may provide a higher torque than a heavier counterweight 30 placed in close proximity to the opening 12. Similarly, changing the weight of the hanger arm 20 or the length of the hanger arm 20 (the distance from the opening 12 to the hanger arm's termination) may alter the net torque placed upon the described system. Thus the weapon hanger device 100 may be designed so that when a bow or other weapon 50 is not place on the hanger arm 20 or the weapon attachment point 21, there is only a small net torque placed on the system in the direction of the counterweight 30, thereby causing a slow or gradual pivoting of the counterweight 30 downward and the hanger arm 20 upward.

In alternative embodiments, the hanger device 100 may include a counterweight 30 of a weight sufficient to cause a torque that is much greater than the torque caused by the hanger arm 20 (with any included weapon attachment point 21, but not greater than the hanger arm 20 with an attached bow or other weapon 50) to cause rapid pivoting of the hanger arm 20.

In a still further embodiment, the weight of the counterweight 30 may be adjustable or customizable. Various methods of altering or adjusting the weight may be well known to those having skill in the art. In one embodiment, the counterweight 30 may have various weights which may be placed or removed on the counterweight 30 in order to increase or decrease weight. In another embodiment, the counterweight 30 may be a substantially hollow element into which materials of varying weights or densities might be placed in order to achieve a precise weight. Regardless of the method of adjustment or customization used, the weight of the counterweight 30 may be set as desired by the user in order to change a speed or angular velocity at which the hanger arm 20 retracts.

Alternatively or additionally, a resistance may be applied to the hanger arm 20 and/or the counterweight 30 in order to set the speed at which the hanger arm 20 retracts. This resistance may be applied by a spring, by friction, or any other suitable means. Retraction speed may be changed by either resisting movement by the counterweight 30 as it rotates downward, resisting movement by the hanger arm 20 as it rotates upward, or a combination of these actions. In other embodiments, no resistance may be used and the retraction may be accomplished exclusively by gravity.

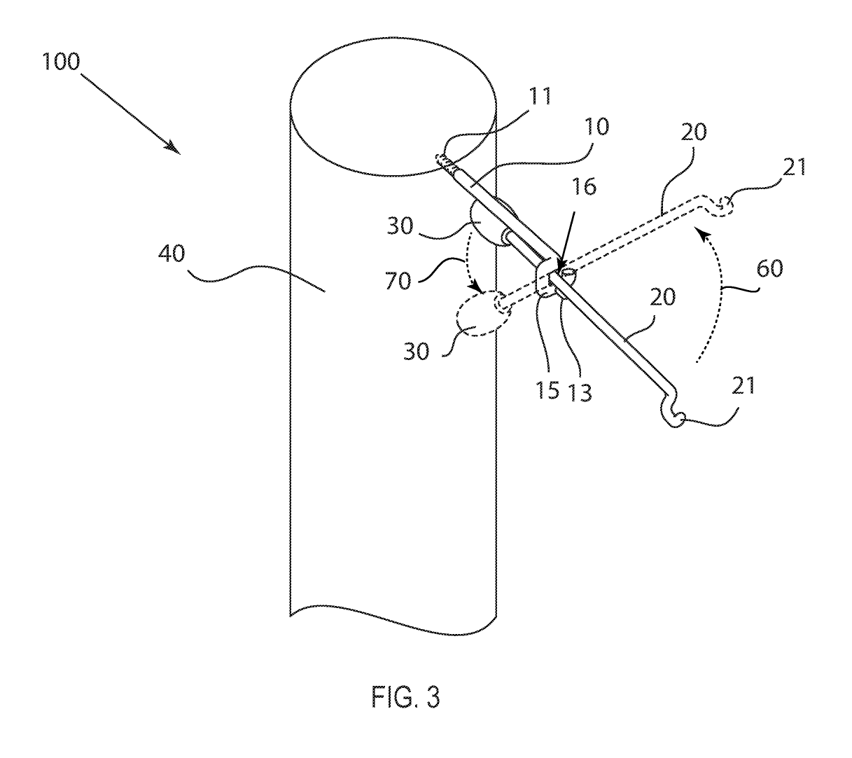

As shown in FIG. 3, in one embodiment the base 10 may include a balance hook 15. The balance hook 15 may be used instead of the opening 12 as a means of supporting the hanger arm 20 and the counterweight 30. According to an embodiment, the balance hook 15 may project below the base 10 and may be oriented so that the hanger arm 20 and/or counterweight 30 placed in the opening 16 of the balance hook 15 extend in substantially the same direction as base 10.

The opening 16 of the balance hook 15 may be configured to receive any portion of the hanger arm 20, the counterweight 30, and/or a connection portion between the two. The balance hook 15 may also include a support tab 13 in order to provide further support for the hanger arm 20 as it extends out from the base 10. In this embodiment, the support tab 13 may also prevent the hanger arm 20 from pivoting farther than a selected angle. Similarly, the counterweight 30 may be disposed primarily under base 10 and may thus also be prevented from pivoting farther than a selected angle by contact with the base 10. Automatic retraction of the hanger arm 20 may occur in this embodiment in the same way as may occur in the embodiment utilizing the opening 12 in the base 10—when a bow or weapon 50 is not on the weapon attachment hook 21, a force of gravity acting on the counterweight 30 may cause it to pivot downward, which may cause the hanger arm 20 to pivot upward thereby retracting out of the user's way.

In a further embodiment, the balance hook 15 may be oriented so that the hanger arm 20 and/or the counterweight 30 placed in the opening 16 of the balance hook 15 may extend at an angle in relation to the direction of the base 10. The balance hook 15 may be oriented in a preset angle in relation to the base 10 or it may be adjustable to any desired angle. This embodiment may further facilitate ease of use in a variety of positions and conditions by allowing the user to choose a convenient orientation. In an embodiment in which the balance hook 15 is oriented to allow the hanger arm 20 and/or the counterweight 30 to extend at an angle in relation to the base 10, it may not be possible to dispose the counterweight 20 under the base 10. While this configuration may thus not be capable of preventing pivoting by contact of the counterweight 30 with base 10, the balance hook 15 may still include support tab 13 to prevent the hanger arm 20 from pivoting farther than a selected angle. Since the hanger arm 20 and the counterweight 30 are connected, this setup may effectively prevent over-pivoting of the counterweight 30 as well. The support tab 13 may extend any length or distance from the balance hook 15 as is desired to provide support for the hanger arm 20.

In further embodiments, the hanger arm 20 may be flexible and/or telescopic, allowing for adjustment of the hanger arm 20 to adapt to a user's particular surroundings. Additionally, this adjustable design may also be applied to base 10 and to the entire weapon hanger device 100. Such a design may greatly increase the portability of the weapon hanger device 100 and make transportation and storage more convenient for a user.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A weapon hanger device, comprising:
a base;
a hanger arm supported by the base, the hanger arm having a weapon attachment point; and
a counterweight connected to the hanger arm.

2. The weapon hanger device of claim 1, wherein the hanger arm is configured to automatically pivot in an upward direction as a result of a gravitational force acting upon the counterweight.

3. The weapon hanger device of claim 2, wherein the hanger arm's automatic pivoting in an upward direction is prevented, and the hanger arm is pulled downward, when a weapon is supported by the weapon attachment point.

4. The weapon hanger device of claim 3, wherein the base includes a support tab which prevents the hanger arm from being pulled downward past a certain angle when a weapon is supported by the weapon attachment point.

5. The weapon hanger device of claim 1, wherein the base includes an opening;
further wherein at least one of the hanger arm and the counterweight pass through the opening.

6. The weapon hanger device of claim 5, wherein both the counterweight and hanger arm are able to pivot in substantially vertical directions around the opening in the base;
further wherein when the weapon attachment point of the hanger arm is not supporting a bow or other weapon, gravity causes the counterweight to automatically pivot in a downward direction and the hanger arm to pivot in an upward direction.

7. The weapon hanger device of claim 1, further comprising:
a connection portion connecting the hanger arm and the counterweight together; and
an opening in the base;
wherein at least one of the hanger arm, the counterweight, and the connection portion pass through the opening in the base.

8. The weapon hanger device of claim 7, wherein the counterweight, hanger arm, and connection portion are able to pivot in substantially vertical directions around the opening in the base;
further wherein when the weapon attachment point of the hanger arm is not supporting a bow or other weapon, gravity causes the counterweight to automatically pivot in a downward direction, the automatic pivoting of the counterweight causes the connection portion to automatically pivot, and the automatic pivoting of the connection portion causes the hanger arm to pivot in an upward direction.

9. The weapon hanger device of claim 1, wherein the base includes an opening;
further wherein the hanger arm and the counterweight are connected through the opening included in the base.

10. The weapon hanger device of claim 9, wherein both the counterweight and hanger arm are able to pivot in substantially vertical directions around the opening included in the base;
further wherein when the weapon attachment point of the hanger arm is not supporting a bow or other weapon, gravity causes the counterweight to automatically pivot in a downward direction and the hanger arm to pivot in an upward direction.

11. The weapon hanger device of claim 1, wherein the weapon attachment point is adjustable.

12. The weapon hanger device of claim 1, wherein the length and orientation of the hanger arm is adjustable.

13. A method of automatically retracting a weapon hanger device, comprising:
providing a weapon hanger device, including:
a base; and
a hanger arm supported by the base, the hanger arm having a weapon attachment point attached to the hanger arm, wherein a weapon is supported by the weapon attachment point;
attaching a counterweight to the hanger arm at an end opposite the weapon attachment point, the counterweight and hanger arm being capable of pivoting around a portion of the base;
removing the weapon supported by the weapon attachment point;
automatically pivoting the counterweight downward as a result of gravity when the weapon supported by the weapon attachment point is removed; and
automatically pivoting the hanger arm upward as a result of the step of automatically pivoting of the counterweight downward.

14. The method of claim 13, further comprising:
controlling at least one of the automatically pivoting of the counterweight as a result of gravity and the automatically pivoting of the hanger arm as a result of the step of automatically pivoting of the counterweight;
wherein the step of controlling is accomplished by a spring.

15. The method of claim 13, further comprising:
controlling at least one of the automatically pivoting of the counterweight as a result of gravity and the automatically pivoting of the hanger arm as a result of the step of automatically pivoting of the counterweight;
wherein the step of controlling is accomplished by use of friction.

16. A weapon hanger device, comprising:
a base, the base having a balance hook disposed under the rest of the base;
a hanger arm connected to a counterweight, wherein the hanger arm includes a weapon attachment hook;
wherein a portion of at least one of the hanger arm and the counterweight is placed in the balance hook such that both the hanger arm and the counterweight are capable of freely pivoting.

17. The weapon hanger device of claim 16, wherein the hanger arm is configured to automatically pivot in an upward direction as a result of a gravitational force acting upon the counterweight.

18. The weapon hanger device of claim 17, wherein the automatic pivoting of the hanger arm in an upward direction may be prevented by supporting a weapon from the weapon attachment hook on the hanger arm.

19. The weapon hanger device of claim 17, wherein the rate of the automatic pivoting of the hanger arm in an upward direction is be controlled by a spring.

20. The weapon hanger device of claim 18, wherein the balance hook includes a support tab which prevents the hanger arm from pivoting past a specific angle.
